(19) United States
(12) Patent Application Publication
(10) Pub. No.: US 2010/0151318 A1
(43) Pub. Date: Jun. 17, 2010

(54) THREE-DIMENSIONAL BATTERY WITH HYBRID NANO-CARBON LAYER

(75) Inventors: SERGEY D. LOPATIN, Santa Clara, CA (US); Christopher Lazik, Fremont, CA (US); Robert Z. Bachrach, Burlingame, CA (US)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/634,095

(22) Filed: Dec. 9, 2009

Related U.S. Application Data
(60) Provisional application No. 61/122,306, filed on Dec. 12, 2008.

(51) Int. Cl. H01M 4/02; H01M 2/14; H01M 4/58; H01M 4/38; H01M 4/48; H01M 4/505; H01M 4/50; H01M 4/52; H01M 4/525; H01M 2/02; H01M 4/04; B05D 5/12

(52) U.S. Cl. 429/163; 429/209; 429/246; 429/231.5; 429/220; 429/231.1; 429/221; 429/224; 429/223; 429/231.3; 427/78; 977/734; 977/742; 977/735; 977/750; 977/752

(57) ABSTRACT

A Li-ion battery cell is formed from deposited thin-film layers and comprises a high-surface-area 3-D battery structure. The high-surface-area 3-D battery structure includes a fullerene-hybrid material deposited onto a surface of a conductive substrate and a conformal metallic layer deposited onto the fullerene-hybrid material. The fullerene-hybrid material is made up of chains of fullerene “onions” linked by carbon nanotubes to form a high-surface-area layer on the conductive substrate and has a “three-dimensional” surface. The conformal metallic layer acts as the active anode material in the Li-ion battery and also has a high surface area, thereby forming a high-surface-area anode. The Li-ion battery cell also includes an ionic electrolyte-separator layer, an active cathodic material layer, and a metal current collector for the cathode, each of which is deposited as a conformal thin film.

### CROSS-REFERENCE TO RELATED APPLICATIONS

This application claims benefit of U.S. provisional patent application Ser. No. 61/122,306 (APPM/013524L), filed Dec. 12, 2008, which is herein incorporated by reference.

### BACKGROUND OF THE INVENTION

1. Field of the Invention

Embodiments of the present invention relate generally to lithium-ion batteries, and more specifically, to a 3-dimensional battery with a hybrid nano-carbon layer and methods of fabricating same using thin-film deposition processes.

2. Description of the Related Art

Fast-charging, high-capacity energy storage devices, such as supercapacitors and lithium-(Li) ion batteries, are used in a growing number of applications, including portable electronics, medical, transportation, grid-connected large energy storage, renewable energy storage, and uninterruptible power supply (UPS). In each of these applications, the charge time and capacity of energy storage devices are important parameters. In addition, the size, weight, and/or expense of such energy storage devices can be significant limitations. Further, low internal resistance is necessary for high performance. The lower the resistance, the less restriction the energy storage device encounters in delivering electrical energy. For example, in the case of super capacitors, lower internal resistance allows faster and more efficient charging and discharging thereof. In the case of a battery, internal resistance in a battery impacts performance by reducing the total amount of useful energy stored by the battery as well as the ability of the battery to deliver the high current pulses demanded by digital devices.

Accordingly, there is a need in the art for faster charging, higher capacity energy storage devices that are smaller, lighter, and can be more cost effectively manufactured. There is also a need in the art for components for an electrical storage device that reduce the internal resistance of the storage device.

### SUMMARY OF THE INVENTION

According to one embodiment of the invention, an electrode structure comprising a conductive substrate, a fullerene-hybrid material formed on a surface of the conductive substrate, and a metallic layer conformally deposited on the fullerene-hybrid material and at least a portion of the surface of the conductive substrate.

According to another embodiment of the invention, a Li-ion battery comprises a conductive substrate, a fullerene-hybrid material formed on a surface of the conductive substrate, a first metallic layer conformally deposited on the fullerene-hybrid material, an electrolyte layer conformally deposited on the metallic layer, an active cathodic material layer conformally deposited on the metallic layer, and a second metallic layer conformally deposited on the metallic layer.

According to one another embodiment of the invention, a lithium-ion battery having an electrode structure comprising an anodic structure, comprising a conductive substrate, a fullerene-hybrid material formed on a surface of the conductive substrate, and an active anodic material layer conformally deposited on the fullerene-hybrid material and at least a portion of the conductive substrate, an electrolyte-separator layer conformally deposited on the active anodic material layer, an active cathodic material layer conformally deposited on the electrolyte-separator layer, and a metallic layer conformally deposited on the cathodic material layer.

According to yet another embodiment of the invention, a lithium-ion battery comprising a conductive substrate, a fullerene-hybrid material formed on a surface of the conductive substrate, a first metallic layer conformally deposited on the fullerene-hybrid material, an anodic material layer conformally deposited on the metallic layer, an electrolyte-separator layer conformally deposited on the anodic material layer, an active cathodic material layer conformally deposited on the electrolyte-separator layer, a second metallic layer conformally deposited on the active cathodic material layer, a thick metallic layer deposited on the conformal metallic layer to form a substantially planar surface, a first contact foil tab connected to the thick metallic layer, a second contact foil tab connected to the conductive substrate, and a packaging encapsulation film-foil applied by lamination.

According to another embodiment of the invention, a material comprises a first carbon fullerene onion, a second carbon fullerene onion connected to the first carbon fullerene onion by a first carbon nano-tube (CNT) having a first diameter, and a third carbon fullerene onion connected to the first carbon fullerene onion by a second CNT having a second diameter, wherein the first and second diameters are less than about half of a diameter of the first carbon fullerene onion.

According to another embodiment of the invention, a method of forming an electrode structure comprises vaporizing a high molecular weight hydrocarbon precursor, directing the vaporized high molecular weight hydrocarbon precursor onto a conductive substrate to deposit a fullerene-hybrid material thereon, and depositing a thin metallic layer onto the fullerene-hybrid material using a thin-film metal deposition process, wherein the thin metallic layer is in good electrical contact with a surface of the conductive substrate, and wherein the high molecular weight hydrocarbon precursor comprises molecules having at least 18 carbon (C) atoms.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a schematic cross-sectional view of high surface area electrode, according to one embodiment of the invention.

FIG. 2 illustrates a conceptual model of a single spherical carbon fullerene.

FIGS. 3A and 3B illustrate conceptual models of different configurations of spherical carbon fullerene onions.

FIG. 4 illustrates a conceptual model of one configuration of carbon nanotube.

FIGS. 5A-E illustrate possible configurations of carbon fullerene onions and carbon nanotubes that may form the three-dimensional structures making up a fullerene-hybrid material, according to embodiments of the invention.

FIGS. 6A-E are schematic illustrations of different configurations of hybrid fullerene chains that may make up a fullerene-hybrid material, according to embodiments of the invention.

FIG. 7A is an SEM image of fullerene-hybrid material showing carbon fullerene onions formed into high-aspect ratio hybrid fullerene chains, according to embodiments of the invention.

FIG. 7B is a TEM image of a multi-walled shell connected by a carbon nanotube to another fullerene onion, according to an embodiment of the invention.

FIG. 8 is a process flow chart summarizing a method for forming a high surface area electrode, according to one embodiment of the invention.

FIG. 9 is an SEM image of a metallic layer conformally deposited on fullerene-hybrid material, according to embodiments of the invention.

FIG. 10 is a schematic diagram of a Li-ion battery electrically connected to a load, according to an embodiment of the invention.

FIGS. 11A-D illustrate partial schematic cross-sectional views of a Li-ion battery cell at different stages of formation, according to one embodiment of the invention.

FIG. 12A illustrates a partial schematic cross-sectional view of a Li-ion battery cell formed from sequentially deposited thin-film layers, according to another embodiment of the invention.

FIG. 12B is a schematic cross-sectional view of a portion of a sequentially deposited thin-film layers, according to an embodiment of the invention.

FIG. 13 is a process flow chart summarizing a method for forming Li-ion battery cell, according to one embodiment of the invention.

### DETAILED DESCRIPTION

Embodiments of the invention contemplate a Lithium-ion (Li-ion) battery cell that is formed from deposited thin-film layers and comprises a high-surface-area 3-dimensional battery structure, and methods of forming same. The high-surface-area anode includes a fullerene-hybrid material deposited onto a surface of a conductive substrate and a conformal metallic layer deposited onto the fullerene-hybrid material. The fullerene-hybrid material is made up of chains of fullerene “onions” linked by carbon nanotubes to form a high-surface-area layer on the conductive substrate, and is produced by a chemical vapor deposition-like (CVD) process. Thus, while the fullerene-hybrid material is formed as a thin-film on the conductive substrate and is generally planar in configuration, the fullerene-hybrid material has a “three-dimensional” surface. The conformal metallic layer is a thin film deposited by a CVD, physical vapor deposition (PVD), atomic layer deposition (ALD), or other metal deposition process, and acts as the active anode material in the Li-ion battery. Because it is conformally deposited onto the three-dimensional surface of the fullerene-hybrid material, the conformal metallic layer also has a high surface area, thereby forming a high-surface-area anode. In addition to the high-surface-area anode structure, the Li-ion battery cell also includes an ionic electrolyte-separator layer, an active cathodic material layer, and a metal current collector for the cathode, each of which is deposited as a thin film.

In one embodiment, a high-surface-area electrode structure comprises a fullerene-hybrid material deposited onto a surface of a conductive substrate and a conformal metallic layer deposited onto the fullerene-hybrid material. Such an electrode structure may be incorporated into an energy storage device, such as a Li-ion battery, a supercapacitor, or a fuel cell.

The method of forming a Li-ion battery, according to one embodiment, includes vaporizing a high molecular weight hydrocarbon precursor, directing the vapor onto a conductive substrate to deposit a fullerene-hybrid material thereon, and depositing a thin metallic layer onto the fullerene-hybrid material using a thin-film metal deposition process. The method of forming the Li-ion battery further includes the deposition of an ionic electrolyte-separator layer, an active cathodic material layer, and a final metal film using thin-film deposition processes.

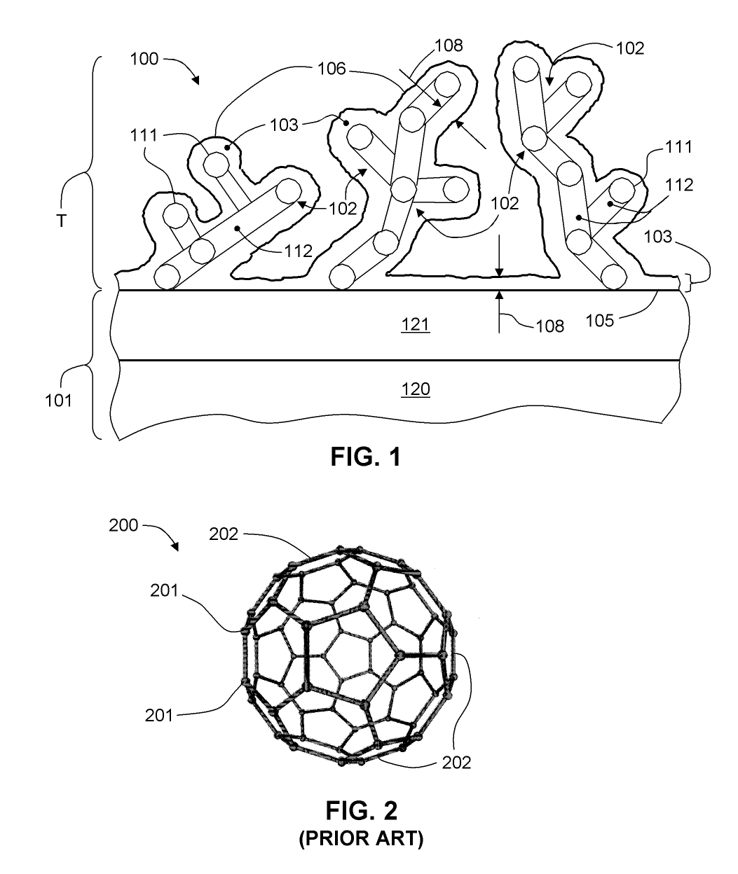

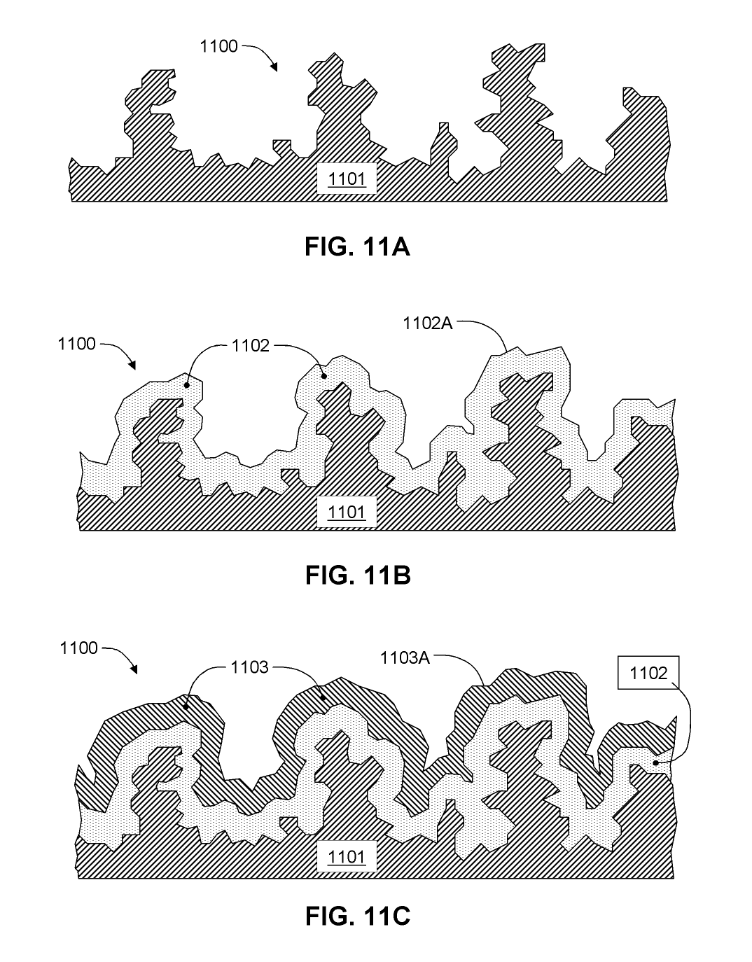

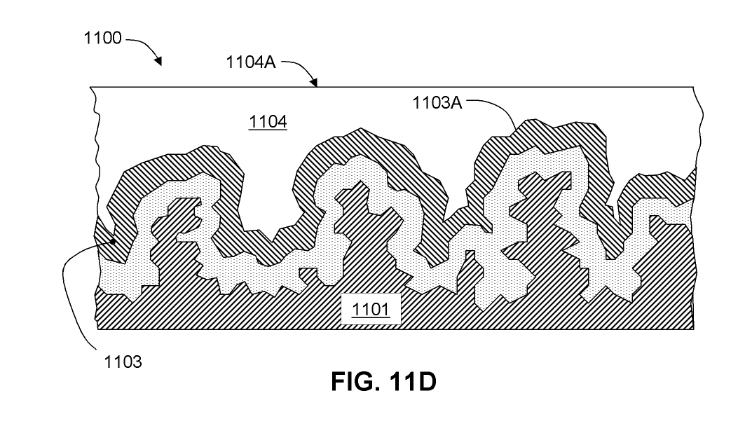

FIG. 1 illustrates a schematic cross-sectional view of high surface area electrode 100, according to one embodiment of the invention. High surface area electrode 100 may be incorporated into a number of energy storage devices, such as a Li-ion battery, a supercapacitor, or a fuel cell. Alternatively, high surface area electrode 100 may serve as the anode structure of a Li-ion battery that is formed from deposited thin-film layers, according to embodiments of the invention, and which is described below in conjunction with FIGS. 11A-D. High surface area electrode 100 includes a conductive substrate 101, a fullerene-hybrid material 102, and a metallic layer 103. Fullerene-hybrid material 102 is comprised of spherical carbon fullerene “onions” 111 and carbon nanotubes 112, and is formed on a surface 105 of conductive substrate 101 by a nano-scale self-assembly process, described below. Metallic layer 103 is deposited on surfaces of fullerene-hybrid material 102, as shown, to form a conductive surface 106 that is “three-dimensional” on the micro-scale, and therefore has a very high surface area.

Conductive substrate 101 may be a metallic plate, a metallic foil, or a non-conductive substrate 120 with a conductive layer 121 formed thereon, as shown in FIG. 1. Metallic plates or foils contemplated by embodiments of the invention may include any metallic, electrically conductive material useful as an electrode and/or conductor in an energy storage device. Such conductive materials include copper (Cu), aluminum (Al), nickel (Ni), stainless steel, palladium (Pd), and platinum (Pt), among others. Non-conductive substrate 120 may be a glass, silicon, or plastic substrate and/or a flexible material, and conductive layer 121 may be formed using conventional thin film deposition techniques known in the art, including PVD, CVD, atomic layer deposition (ALD), thermal evaporation, and electrochemical plating, among others. Conductive layer 121 may include any metallic, electrically conductive material useful as an electrode in an energy storage device, as listed above for conductive substrate 101.

Fullerene-hybrid material 102 is made up of spherical carbon fullerene onions 111 connected by carbon nanotubes 112, as illustrated in FIG. 1. Carbon fullerenes are a family of carbon molecules that are composed entirely of carbon and are in the form of a hollow sphere, ellipsoid, tube, or plane. The carbon fullerene onion is a variation of spherical fullerene carbon molecule known in the art and is made up of multiple nested carbon layers, where each carbon layer is a spherical carbon fullerene, or “buckyball,” of increasing diameter. Carbon nanotubes, also referred to as “buckytubes,” are cylindrical fullerenes, and are usually only a few nanometers in diameter and of various lengths. Carbon nanotubes are also known in the art when formed as separate structures and are not connected to fullerene onions. The unique molecular structure of carbon nanotubes results in extraordinary macroscopic properties, including high tensile strength, high electrical conductivity, high ductility, high resistance to heat, and relative chemical inactivity, many of which are useful for components of energy storage devices.

The inventors have determined through scanning electron microscope (SEM) imagery that the diameter of the spherical carbon fullerene onions 111 and length of the carbon nanotubes 112 in fullerene-hybrid material 102 ranges between about 5 nm and 50 nm. Any substantial deposition of fullerene-hybrid material 102 on surface 105 will ultimately enhance the surface area of conductive surface 106. However, it is believed that such surface area enhancement is optimized when the nominal thickness T of fullerene-hybrid material 102 is between about 50 nm and about 300 microns. In one embodiment, thickness T of fullerene-hybrid material 102 is between about 30 and 50 microns.

FIG. 2 illustrates a conceptual model of a carbon fullerene 200, which may make up one of the multiple layers of the spherical carbon fullerene onions 111 in fullerene-hybrid material 102. Spherical carbon fullerene 200 is a C₆₀ molecule and consists of 60 carbon atoms 201 configured in twenty hexagons and twelve pentagons as shown. A carbon atom 201 is located at each vertex of each polygon and a bond is formed along each polygon edge 202. In scientific literature it is reported that the van der Waals diameter of spherical carbon fullerene 200 is about 1 nanometer (nm), and the nucleus-to-nucleus diameter of spherical carbon fullerene 200 is about 0.7 nm.

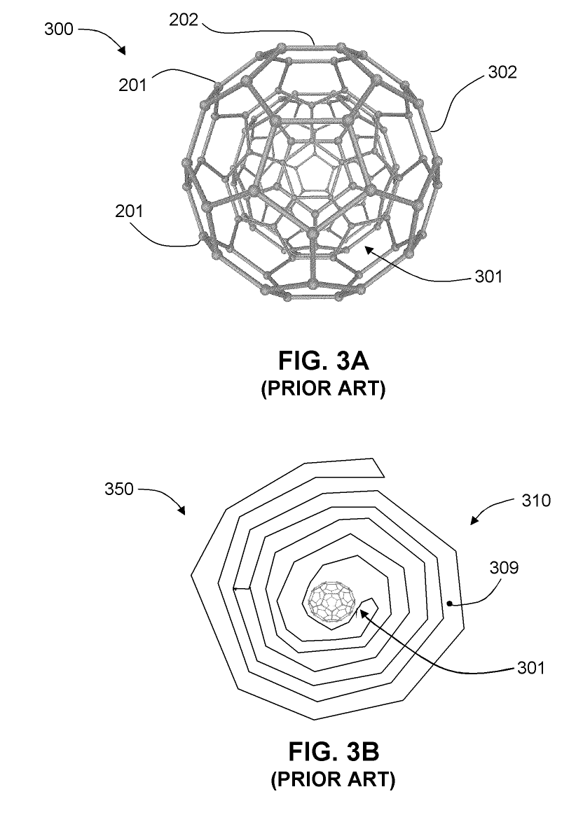

FIG. 3A illustrates a conceptual model 300 of one configuration of a spherical carbon fullerene onion 111, as reported in the literature. In this embodiment, spherical carbon fullerene onion 111 includes a C₆₀ molecule 301 similar to spherical carbon fullerene 200 and one or more larger carbon fullerene molecules 302 surrounding C₆₀ molecule 301, forming a carbon molecule having a multi-wall shell, as shown. Modeling well known in the art indicates that C₆₀ is the smallest spherical carbon fullerene present in Fullerene onion structures, such as spherical carbon fullerene onion 111. Larger carbon fullerene molecule 302 is a spherical carbon fullerene molecule having a larger carbon number than C₆₀ molecule 301, e.g., C₇₀, C₇₂, C₈₄, C₁₁₂, etc. In one embodiment, C₆₀ molecule 301 may be contained in multiple larger carbon fullerene onion layers, e.g., C₇₀, C₈₄, C₁₁₂, etc., thereby forming a fullerene onion having more than two layers.

FIG. 3B illustrates a conceptual model 350 of another configuration of a spherical carbon fullerene onion 111, as reported in the literature. In this embodiment, spherical carbon fullerene onion 111 includes C₆₀ molecule 301 and multiple layers of graphene planes 309 surrounding C₆₀ molecule 301 and forming a carbon molecule having a multi-wall shell 310, as shown. Alternatively, a spherical carbon fullerene having a larger carbon number than 60 may form the core of spherical carbon fullerene onion 111, e.g., C₇₀, C₈₄, C₁₁₂, etc. In another embodiment, a nano-particle comprised of metal, e.g., nickel (Ni), cobalt (Co), palladium (Pd), and iron (Fe), metal oxide, or diamond may instead form the core of spherical carbon fullerene onion 111.

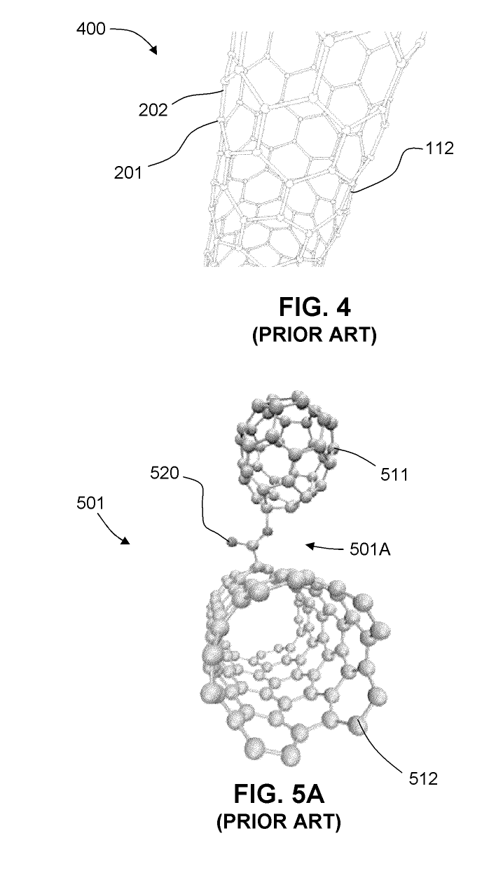

As described above in conjunction with FIG. 1, carbon fullerene onions 111 of fullerene-hybrid material 102 are connected to each other by carbon nanotubes 112, thereby forming extended three-dimensional structures on surface 105 of conductive substrate 101. FIG. 4 illustrates a conceptual model 400 of one configuration of carbon nanotube 112, according to an embodiment of the invention. Conceptual model 400 shows the three-dimensional structure of carbon nanotube 112. As with spherical carbon fullerene onion 111, carbon atoms 201 reside at each vertex of the polygons that make up carbon nanotube 112, and a bond is formed along each polygon edge 202. The diameter 401 of carbon nanotube 112 may be between about 1-10 nm.

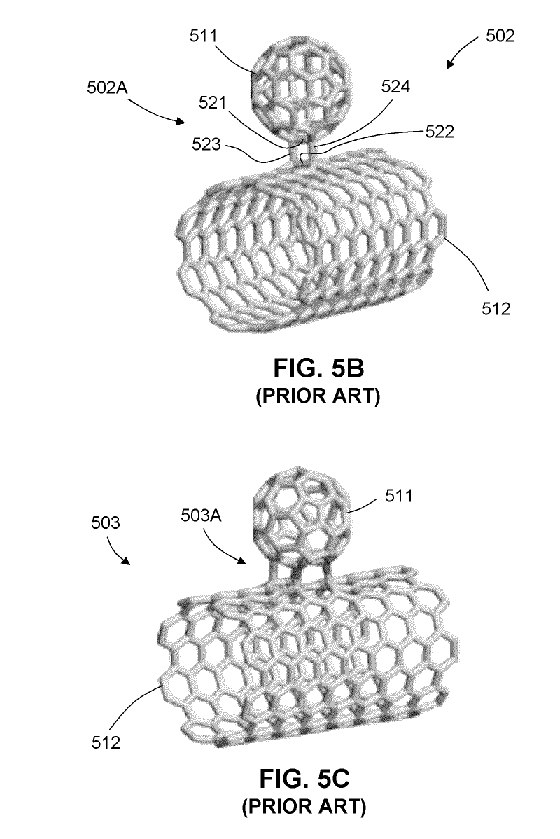

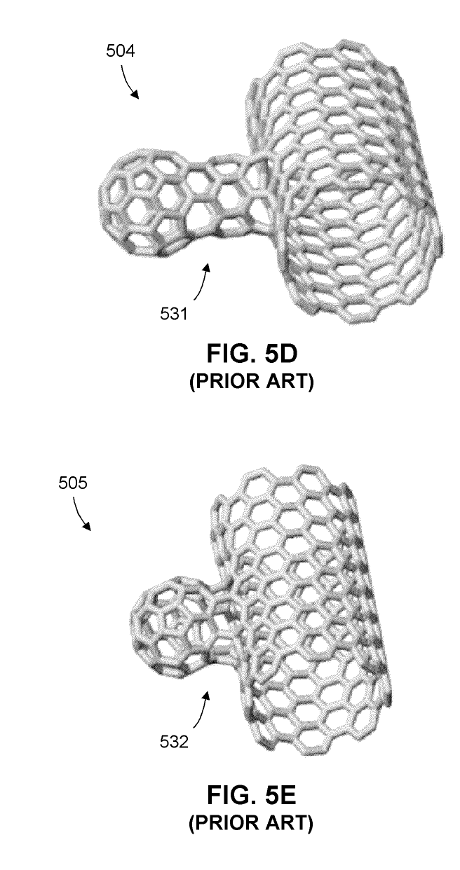

FIGS. 5A-E illustrate a variety of possible configurations 501-505 of carbon fullerene onions 111 and carbon nanotubes 112 that may form the three-dimensional structures making up fullerene-hybrid material 102, according to embodiments of the invention. Configurations 501-505 are based on theoretical modeling known in the art and have been confirmed in part by images of fullerene-hybrid material 102 obtained by the inventors using a SEM. As shown in FIGS. 5A-C, respectively, configurations 501, 502, and 503 depict the connection between a spherical carbon fullerene 511 and a carbon nanotube 512 as one or more single bonds. In configuration 501, connection 501A consists of a single carbon bond 520 or chain of single carbon bonds formed between a single vertex, i.e., a carbon atom, of spherical carbon fullerene 511 and a single vertex of carbon nanotube 512. In configuration 502, spherical carbon fullerene 511 is oriented so that a carbon bond 521 contained therein is oriented substantially parallel and proximate to a corresponding carbon bond 522 of carbon nanotube 512, as shown. In such a configuration, connection 502A consists of two carbon bonds 523, 524, which are formed as shown between the two vertices of carbon bond 521 and carbon bond 522. In configuration 503, spherical carbon fullerene 511 is oriented so that a polygon face is oriented substantially parallel and proximate to a corresponding polygon face of carbon nanotube 512. The vertices of the corresponding polygon faces are aligned, and the connection 503A consists of three to six carbon bonds formed between vertices of the two parallel polygon faces of spherical carbon fullerene 511 and carbon nanotube 512, as shown. Configurations 504 and 505, illustrated in FIGS. 5D and 5E, respectively, depict the connection between a spherical carbon fullerene 511 and carbon nanotube 512 as nanotube-like structures 531, 532, respectively.

For clarity, spherical carbon fullerene 511 in configurations 501-505 is illustrated as a single-walled spherical carbon fullerene. One of skill in the art will appreciate that configurations 501-505 are also equally applicable to multi-walled fullerene structures, i.e., carbon fullerene onions, that may be contained in fullerene-hybrid material 102. In one embodiment, the connection between spherical carbon fullerenes 511 and carbon nanotubes 512 in fullerene-hybrid material 102 may include a combination of two or more of configurations 501-505.

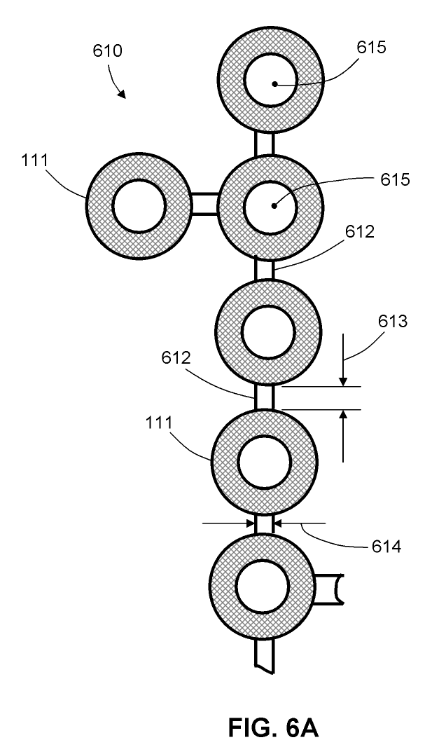

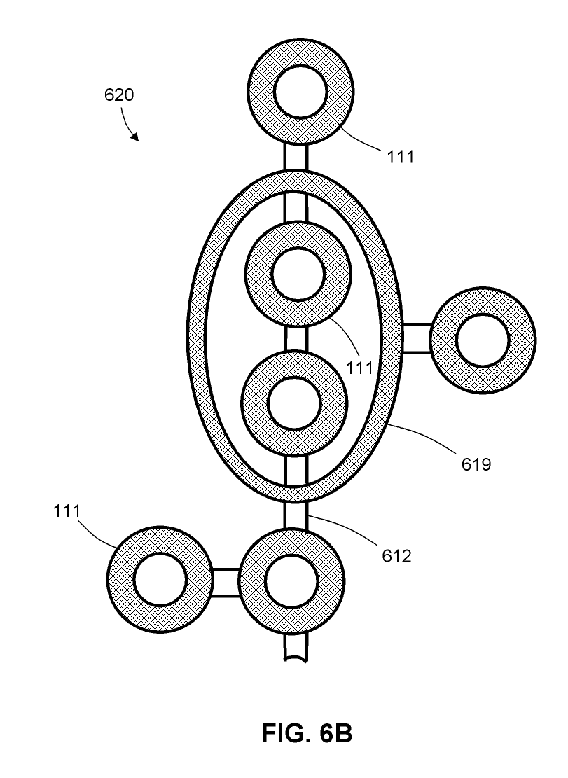

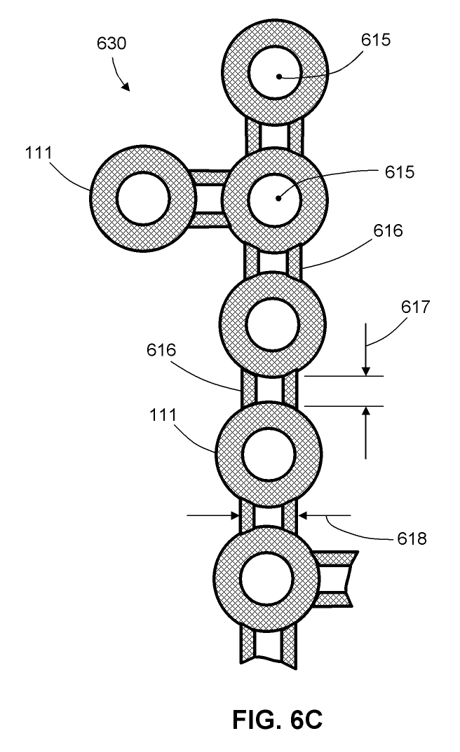

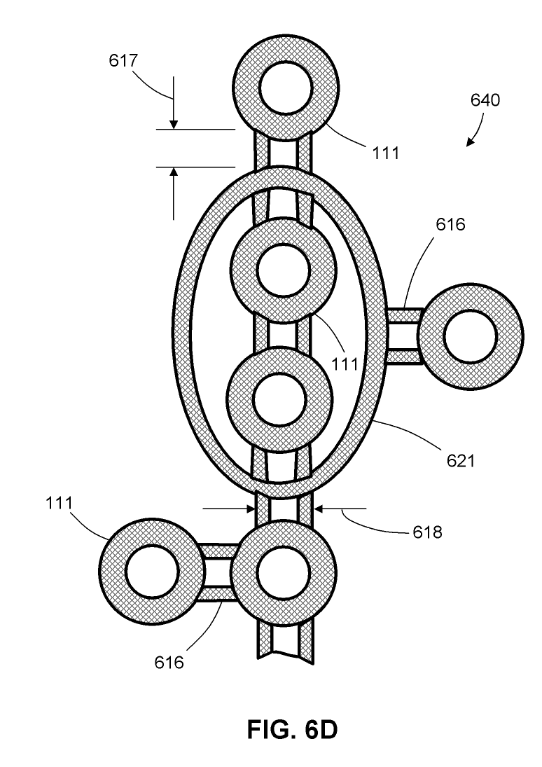

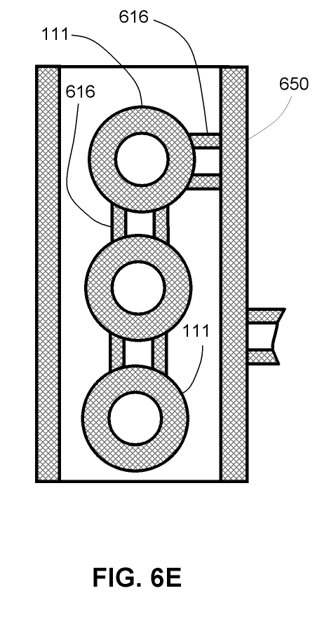

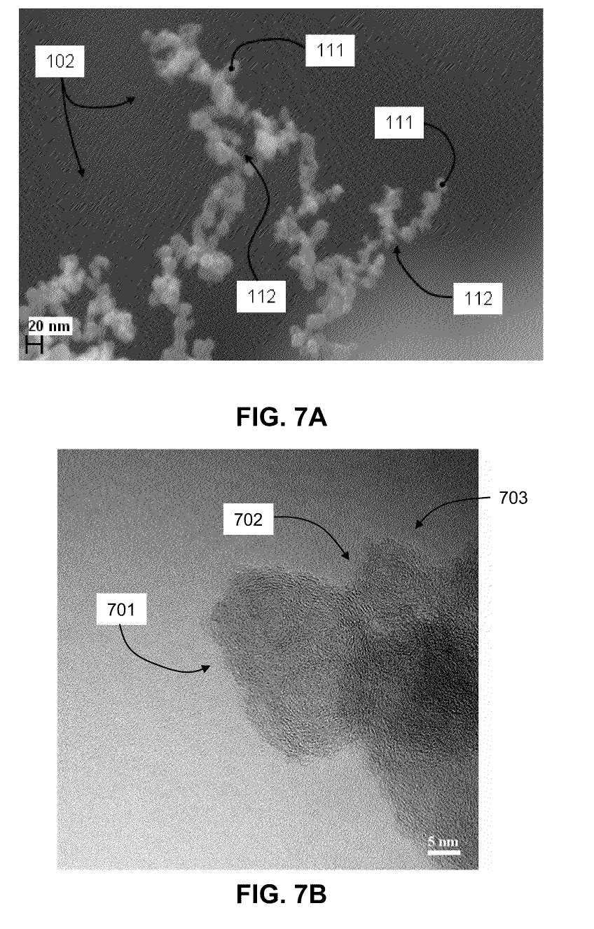

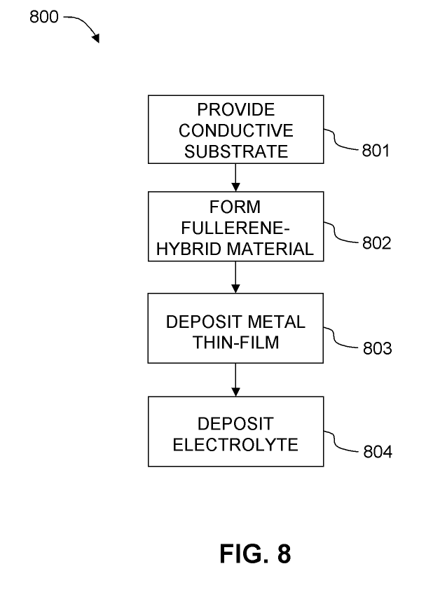

FIGS. 6A-E are schematic illustrations of different configurations of hybrid fullerene chains 610, 620, 630, 640, and 650 that may make up fullerene-hybrid material 102, according to embodiments of the invention. FIGS. 6A-E are based in part on images of fullerene-hybrid material 102 obtained by the inventors using SEM and transmission electron microscopy (TEM). FIG. 6A schematically depicts a hybrid fullerene chain 610, which is a high-aspect ratio configuration of a plurality of spherical carbon fullerene onions 111 connected by single-walled carbon nanotubes 612. While depicted in FIGS. 6A-E as circular in cross-section, it is known in the art that spherical carbon fullerene onions 111 may not be perfectly spherical. Spherical carbon fullerene onions 111 may also be oblate, oblong, elliptical in cross-section, etc. In addition, the inventors have observed such asymmetrical and/or aspherical shapes of spherical carbon fullerene onions 111 via TEM and SEM, as shown in FIGS. 7 and 8. Single-walled carbon nanotubes 612 are substantially similar to single-walled carbon nanotubes 112, described above in conjunction with FIG. 4, and are about 1-10 nm in diameter. As shown, single-walled carbon nanotubes 612 form relatively low-aspect ratio connections between spherical carbon fullerene onions 111, where the length 613 of each single-walled carbon nanotube 612 is approximately equal to the diameter 614 thereof. Spherical carbon fullerene onions 111 may each include a C₆₀ molecule or other nano-particle forming the core 615 of each spherical carbon fullerene onion 111 and multiple layers of graphene planes, as described above in conjunction with FIGS. 3A-B.

FIG. 6B schematically depicts a hybrid fullerene chain 620, which is a high-aspect ratio configuration of spherical carbon fullerene onions 111 connected by single-walled carbon nanotubes 612 and also includes single-walled carbon nano-tube shells 619 surrounding one or more of the carbon fullerene onions 111. FIG. 6C schematically depicts a hybrid fullerene chain 630, which is a high-aspect ratio configuration of a plurality of spherical carbon fullerene onions 111 connected by multi-walled carbon nanotubes 616. As shown, multi-walled carbon nanotubes 616 form relatively low-aspect ratio connections between spherical carbon fullerene onions 111, where the length 617 of each multi-walled carbon nanotube 616 is approximately equal to the diameter 618 thereof. FIG. 6D schematically depicts a hybrid fullerene chain 640, which is a high-aspect ratio configuration of spherical carbon fullerene onions 111 connected by multi-walled carbon nanotubes 616 and also includes one or more multi-walled carbon nano-tube shells 621 surrounding one or more of the carbon fullerene onions 111. FIG. 6E depicts a cross-sectional view of a multi-wall carbon nano-tube 650, which may form part of a high-aspect ratio structure contained in fullerene-hybrid material 102. As shown, multi-wall carbon nano-tube 650 contains one or more spherical carbon fullerene onions 111 connected to each other and to carbon nano-tube 650 by multi-walled carbon nanotubes 616, where the spherical carbon fullerene onions 111 are contained inside the inner diameter of carbon nano-tube 650.

FIG. 7A is an SEM image of fullerene-hybrid material 102 showing carbon fullerene onions 111 formed into high-aspect ratio hybrid fullerene chains, according to embodiments of the invention. In some locations, carbon nanotubes 112 connecting carbon fullerene onions 111 are clearly visible. FIG. 7B is a TEM image of a multi-walled shell 701 connected by a carbon nanotube 702 to another fullerene onion 703, according to an embodiment of the invention.

One of ordinary skill in the art will appreciate that hybrid fullerene chains 610, 620, 630, 640, and 650, according to embodiments of the invention, enable the formation of fullerene-hybrid material 102 on a conductive substrate. First, such hybrid fullerene chains have extremely high surface area. In addition, due to the nano-scale self-assembly process by which they are formed, the hybrid fullerene chains forming fullerene-hybrid material 102 also possess high tensile strength, electrical conductivity, heat resistance, and chemical inactivity. Further, the method of forming such structures is well-suited to the formation of a high-surface-area electrode, since the hybrid fullerene chains forming fullerene-hybrid material 102 are mechanically and electrically coupled to a conductive substrate as they are formed, rather than being formed in a separate process and then deposited onto a conductive substrate.

Referring to FIG. 1, metallic layer 103 is deposited on surfaces of fullerene-hybrid material 102. To maximize the conductive surface area of high surface area electrode 100, metallic layer 103 is deposited conformally, as illustrated in FIG. 1. To further enhance the surface area of conductive surface 106, in one embodiment, the thickness 108 of metallic layer 103 may be limited to no more than about 100 nm, so that the gaps present between the three-dimensional structures of fullerene-hybrid material 102 are not completely filled by metallic layer 103. In another embodiment, thickness 108 of metallic layer 103 may be up to one micron. Metallic layer 103 may include any metallic, electrically conductive material useful as an electrode in an energy storage device. Such conductive materials include copper (Cu), tungsten (W), palladium (Pd), and platinum (Pt), among others. For example, palladium and platinum are particularly useful for electrode structures used in fuel cells, whereas copper, tungsten, aluminum (Al), ruthenium (Ru), and nickel (Ni) may be better suited for use in batteries and/or supercapacitors. When high surface area electrode 100 serves as a high-surface-area anode structure of a Li-ion battery formed from deposited thin-film layers, metallic layer 103 includes an active anodic material, such as metal alloys, their oxides, and their composites with carbon.

In addition to providing conductive surface 106 with a high surface area, metallic layer 103 is in good electrical contact with surface 105 of conductive substrate 101. Thus, there is a low-resistivity electrical path between conductive surface 106 and surface 105, and conductive surface 106 acts as the top surface of high surface area electrode 100. In this way, high surface area electrode 100 has a much higher surface area than an electrode with a conventional flat surface, such as surface 105. In one embodiment, high surface area electrode 100 may have a surface area that is one or more orders of magnitude greater than an electrode with a conventional flat surface, thereby significantly reducing the internal resistance of an energy storage device that includes high surface area electrode 100. In one embodiment, high surface area electrode 100 may have a surface area that is 100 to 1000 times greater than an electrode with a conventional flat surface.

Metallic layer 103 may be formed in a number of ways on the structures making up fullerene-hybrid material 102. Because conformal deposition may enhance the surface area of conductive surface 106, CVD is a preferred technique for depositing metallic layer 103. Both low-vacuum, i.e., near atmospheric, and high-vacuum CVD processes may be used. Atmospheric and near-atmospheric CVD processes allow deposition onto larger surface area substrates, higher throughput, and lower-cost processing equipment. In-situ processes allow the formation of fullerene-hybrid material 102, metallic layer 103, and conductive layer 121 using consecutive deposition processes without exposure of the substrate to atmosphere. Higher-vacuum processes may provide lower potential contamination of deposited layers and, thus, better adhesion between deposited layers. In another embodiment, a CVD process is not used to deposit metallic layer 103. Instead, metallic layer 103 is formed using a PVD or thermal evaporation process. In yet another embodiment, a conductive seed layer may be deposited on fullerene-hybrid material 102, and metallic layer 103 may then be formed by an electrochemical plating process. The conductive seed layer may be deposited using PVD, CVD, ALD, thermal evaporation, or an electroless plating process. Such methods are known in the art and are not described herein.

In sum, conductive surface 106 of high surface area electrode 100 has a very high surface area in comparison to a conventional electrode. Therefore, high surface area electrode 100 is useful in reducing the internal resistance of an energy storage device, such as a battery, supercapacitor, or fuel cell, when incorporated therein. This is particularly true since the interface between and an electrode and an electrolyte can be a significant source of electrical resistance during operation, and maximizing the area of such an interface can reduce the electrical resistance produced thereby.

FIG. 8 is a process flow chart summarizing a method 800 for forming high surface area electrode 100, according to one embodiment of the invention. In step 801, conductive layer 121 is formed on a surface of non-conductive substrate 120. Conductive layer 121 may be formed using one or more metal thin-film deposition techniques known in the art, including PVD, CVD, ALD, and thermal evaporation, among others. Alternatively, a conductive substrate is provided in step 801, such as a metallic foil or metallic plate.

In step 802, fullerene-hybrid material 102 is formed on the conductive substrate. Unlike prior art methods for forming Fullerenes, no catalytic nano-particles, such as iron (Fe) or nano-diamond particles, are used in step 802 to form Fullerene-hybrid material 102. Instead, fullerene-hybrid material 102 is formed on a surface 105 of conductive substrate 101 using a CVD-like process that allows the carbon atoms in a hydrocarbon precursor gas to undergo a continuous nano-scale self-assembly process on surface 105.

First, a high molecular weight hydrocarbon precursor, which may be a liquid or solid precursor, is vaporized to form a precursor gas. A hydrocarbon precursor having 18 or more carbon atoms may be used, such as C₂₀H₄₀, C₂₀H₄₂, C₂₂H₄₄, etc. The precursor is heated to between 300° C. and 1400° C., depending on the properties of the particular hydrocarbon precursor used. One of skill in the art can readily determine the appropriate temperature at which the hydrocarbon precursor should be heated to form a vapor for such a process.

Next, the hydrocarbon precursor vapor is directed onto the surface of the conductive substrate, where the temperature of the conductive substrate is maintained at a relatively cold temperature, i.e., no greater than about 220° C. The temperature at which the conductive surface is maintained during this process step may vary as a function of substrate type. For example, in one embodiment, the substrate includes a non-temperature resistant polymer, and may be maintained at a temperature between about 100° C. and 300° C. during step 802. In another embodiment, the substrate is a copper substrate, such as a copper foil, and may be maintained at a temperature between about 300° C. and 1000° C. during step 802. In yet another embodiment, the substrate consists of a more heat-resistant material, such as stainless steel, and is maintained at a temperature of up to about 1000° C. during step 802. The substrate may be actively cooled during the deposition process with backside gas and/or a mechanically cooled substrate support. Alternatively, the thermal inertia of the substrate may be adequate to maintain the conductive surface of the substrate at an appropriate temperature during the deposition process. A carrier gas, such as argon (Ar) or nitrogen (N₂), may be used to better deliver the hydrocarbon precursor gas to the surface of the conductive substrate. For improved uniformity of gas flow, the mixture of hydrocarbon precursor vapor and carrier gas may be directed to the conductive surface of the substrate through a showerhead. Alternatively, the hydrocarbon precursor vapor and/or a carrier gas may be introduced into a process chamber via one or more gas injection jets, where each jet may be configured to introduce a combination of gases, or a single gas, e.g., carrier gas, hydrocarbon precursor vapor, etc.

Last, the fullerene-hybrid material is formed on the surface of the conductive substrate. Under the conditions so described, the inventors have determined that carbon nano-particles contained in the hydrocarbon precursor vapor will “self-assemble” on the cool surface into fullerene-hybrid material 102, i.e., a matrix of three-dimensional structures made up of fullerene onions connected by nanotubes. Thus, no catalytic nano-particles are used to form fullerene-hybrid material 102. In addition, the fullerene-containing material that forms fullerene-hybrid material 102 does not consist of individual nano-particles and molecules. Rather, fullerene-hybrid material 102 is made up of high aspect ratio, chain-like structures, such as hybrid fullerene chains 610, 620, 630, and 640, illustrated in FIGS. 6A-D. Such high aspect ratio, chain-like structures are mechanically bonded to the surface of the conductive substrate, as illustrated in FIG. 1. Thus, fullerene-hybrid material 102 can be subsequently incorporated into the structure of a high surface area electrode.

Experimental observations at different times during the self-assembly process by SEM show that self-assembly begins with the formation of scattered individual nano-carbon chains having high aspect ratios. The fullerene onion diameters are in the range of 5-20 nm and the hybrid fullerene chains are up to 20 micron in length. It is believed that the growth of such fullerene chains is initiated on copper grain boundaries and/or defects in the copper lattice. As the self-assembly progresses, the hybrid fullerene chains become interconnected with each other to form a layer of highly porous material, i.e., fullerene-hybrid material 102 in FIG. 1. The self-assembly process of interconnected hybrid fullerene chains continues as a self-catalytic process. Layers of 1, 10, 20, 30, 40, and 50 microns thick nano-Carbon material have been observed.

It is noted that the process described in step 802 is substantially different from processes known in the art for depositing carbon nanotube-containing structures on a substrate. Such processes generally require the formation of carbon nanotubes or graphene flakes in one process step, the formation of a slurry containing the pre-formed carbon nanotubes or graphene flakes and a binding agent in a second process step, the application of the slurry to a substrate surface in a third process step, and the anneal of the slurry in a final process step to form an interconnected matrix of carbon molecules on the substrate. The method described herein is significantly less complex, can be completed in a single processing chamber, and relies on a continuous self-assembly process to form high aspect ratio carbon structures on a substrate rather than on an anneal step. The self-assembly process is believed to form carbon structures of greater chemical stability and higher electrical conductivity than slurry-based carbon structures, both of which are beneficial properties for components of energy storage devices. Further, the lack of a high temperature anneal process allows for the use of a wide variety of substrates on which to form the carbon structures, including very thin metal foils and polymeric films, among others.

In one process example, a fullerene-hybrid material substantially similar to fullerene-hybrid material 102 is formed on a conductive layer formed on the surface of a flexible non-conductive substrate, where the non-conductive substrate is a heat resistance polymer and the conductive layer is a copper thin-film formed thereon. A precursor containing a high molecular weight hydrocarbon is heated to 300-1400° C. to produce a hydrocarbon precursor vapor. Argon (Ar), nitrogen (N₂), air, carbon monoxide (CO), methane (CH₄), and/or hydrogen (H₂) at a maximum temperature of 700-1400° C. is used as a carrier gas to deliver the hydrocarbon precursor vapor to a CVD chamber having a process volume of approximately 10-50 liters. The flow rate of the hydrocarbon precursor vapor is approximately 0.2 to 5 sccm, the flow rate of the carrier gas is approximately 0.2 to 5 sccm, and the process pressure maintained in the CVD chamber is approximately 10⁻² to 10⁻⁴ Torr. The substrate temperature is maintained at approximately 100° C. to 700° C., and the deposition time is between about 1 min and 60 minutes, depending on the thickness of deposited material desired. In one embodiment, oxygen (O₂) or air is also introduced into the process volume of the CVD chamber at a flow rate of 0.2-1.0 sccm at a temperature of between about 10° C. and 100° C. to produce a combustion-like CVD process. A reaction takes place at about 400° C. and 700° C. in a reaction region between the substrate surface and the gas injection jets or showerhead. The above process conditions yield a fullerene-hybrid material substantially similar to fullerene-hybrid material 102, as described herein.

Preferred CVD processes for performing step 802 include aerosol assisted CVD (AACVD) and direct liquid injection (DLICVD), but other techniques, including low pressure CVD (LPCVD), subatmospheric CVD (SACVD), atmospheric pressure CVD (APCVD) and discharge-enhanced CVD (DECVD) processes may be used to complete step 802.

In step 803, metallic layer 103 is deposited onto fullerene-hybrid material 102 using a thin film deposition process. In one embodiment, a conventional CVD tungsten (W) process is used to deposit a conformal layer of W on fullerene-hybrid material 102, as illustrated in FIG. 1. Such CVD processes are well known in the art, and given a substrate, a process chamber, and a target film thickness, one skilled in the art can readily devise the appropriate process conditions to form metallic layer 103 on fullerene-hybrid material 102, i.e., chamber pressure, process gas flow rates and temperatures, etc. The inventors have determined that the structural stability of fullerene-hybrid material 102 remains unchanged after the CVD tungsten deposition process, making such a process suitable for forming metallic layer 103. LPCVD, SACVD, APCVD and plasma-enhanced CVD (PECVD) processes may be used for step 803. Deposition of other metals are also contemplated to form metallic layer 103, including platinum (Pt) and palladium (Pd). Alternatively, PVD, thermal evaporation, electrochemical plating, and electroless plating processes may be used to form metallic layer 103 on fullerene-hybrid material 102. Materials that may be deposited to form metallic layer 103 include copper (Cu), cobalt (Co), nickel (Ni), aluminum (Al), zinc (Zn), magnesium (Mg), tungsten (W), their alloys, their oxides, and/or their lithium-containing compounds. Other materials that may form metallic layer 103 include tin (Sn), tin-cobalt (SnCo), tin-copper (Sn—Cu), tin-cobalt-titanium (Sn—Co—Ti), tin-copper-titanium (Sn—Cu—Ti), and their oxides.

In step 804, an electrolyte may optionally be deposited onto conductive surface 106. In this way, a complete electrode structure for a battery or supercapacitor may be formed in a series of in-situ deposition steps. Techniques for depositing an electrolyte onto conductive surface 106 of metallic layer 103 include: PVD, CVD, wet deposition, and sol-gel deposition. The electrolyte may be formed from Lithium Phosphorous OxyNitride (LiPON), lithium-oxygen-phosphorus (LOP), lithium-phosphorus (LiP), lithium polymer electrolyte, lithium bisoxalatoborate (LiBOB), lithium hexafluorophosphate (LiPF₆) in combination with ethylene carbonate (C₃H₄O₃), and dimethylene carbonate (C₃H₆O₃). In another embodiment, ionic liquids may be deposited to form the electrolyte.

In one embodiment, steps 802 and 803, i.e., formation of fullerene-hybrid material 102 and deposition of metallic layer 103, are performed in-situ. In this embodiment, formation of fullerene-hybrid material 102 is performed in a low-vacuum environment, such as an APCVD or SACVD chamber, and deposition of metallic layer 103 is performed in a slightly higher vacuum environment, such as an SACVD or LPCVD chamber. Alternatively, both processes may be performed in a single chamber, and the metal deposition process of step 803 is simply performed at the lower chamber pressure required by the metal deposition process.

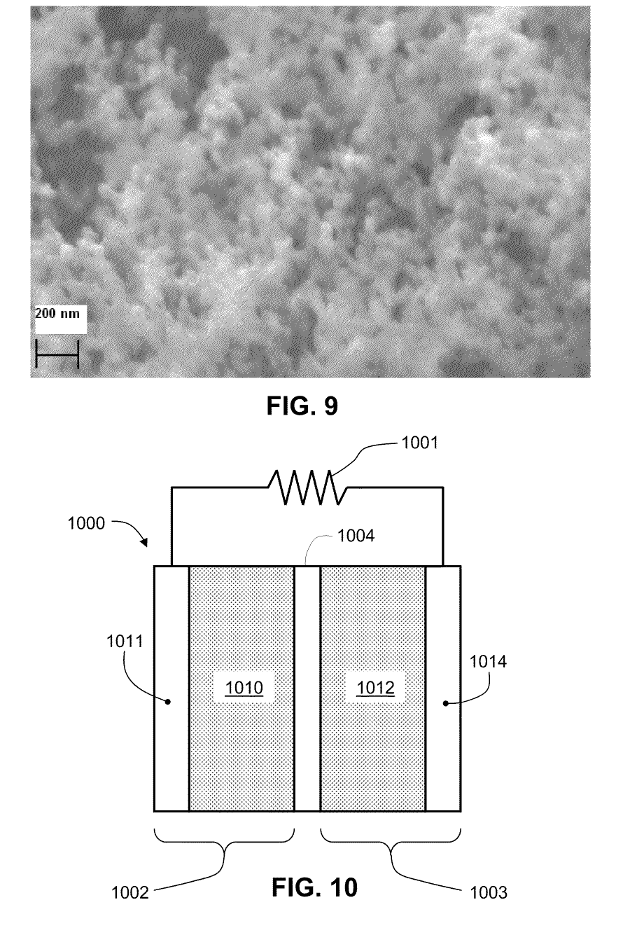

FIG. 9 is an SEM image of metallic layer 103 conformally deposited on fullerene-hybrid material 102, using the above-described method 800, according to embodiments of the invention. Clearly visible is the three-dimensional surface of metallic layer 103.

In one embodiment, a high surface area electrode substantially similar to high surface area electrode 100 in FIG. 1 is incorporated in an energy storage device, such as a Li-ion battery or supercapacitor. FIG. 10 is a schematic diagram of a Li-ion battery 1000 electrically connected to a load 1001, according to an embodiment of the invention. The primary functional components of Li-ion battery 1000 include an anode structure 1002, a cathode structure 1003, a separator layer 1004, and an electrolyte (not shown). A variety of materials may be used as the electrolyte, such as a lithium salt in an organic solvent, and is contained in anode structure 1002, cathode structure 1003, and separator layer 1004.

Anode structure 1002 and cathode structure 1003 each serve as a half-cell of Li-ion battery 1000, and together form a complete working cell of Li-ion battery 1000. Anode structure 1002 includes an electrode 1011 and an intercalation material 1010 that acts as a carbon-based intercalation host material for retaining lithium ions. Similarly, cathode structure 1003 includes an electrode 1014 and an intercalation host material 1012 for retaining lithium ions, such as a metal oxide. Separator layer 1004 is a dielectric, porous layer that electrically isolates anode structure 1002 from cathode structure 1003. Electrodes 1011 and 1014 may each be substantially similar in configuration to high surface area electrode 100 in FIG. 1. One of skill in the art will appreciate that electrodes 1011 and 1014 significantly reduce the internal resistance of Li-ion battery 1000 when compared to a conventional Li-ion battery.

In one embodiment, a complete Li-ion battery cell may be formed from sequentially deposited thin-film layers and may comprise a high-surface-area anode structure that is substantially similar to high surface area electrode 100 in FIG. 1. FIGS. 11A-D illustrate partial schematic cross-sectional views of a Li-ion battery cell 1100 at different stages of formation, according to embodiments of the invention.

In FIG. 11A, an anodic structure 1101 is depicted prior to the deposition of other layers that make up Li-ion battery cell 1100, and may be formed using method 800, described above. Anodic structure 1101 is substantially similar in configuration to high surface area electrode 100 in FIG. 1, and includes a conductive substrate, a fullerene-hybrid material, and a layer of an active anodic material, which are not shown for clarity. As noted above in conjunction with FIG. 1, the conductive substrate may be a flexible substrate, such as a metal foil or a polymeric film having a conductive layer deposited thereon and includes a current collector for the anode of Li-ion battery cell 1100.

In FIG. 11B, an electrolyte layer 1102 has been conformally deposited on anodic structure 1101, as shown. Electrolyte layer 1102 may be formed using the methods described above in step 804 of method 800 and is an electrically insulating lithium ion conductor, such as LiPON or other lithium-containing inorganic films. In one embodiment, LiPON is formed by low pressure sputter deposition, i.e., <10 mT, of lithium orthophosphate (Li₃PO₄) in nitrogen. The conformal deposition of electrolyte layer 1102 ensures that surface 1102A provides a very high surface area interface for subsequently deposited layers of Li-ion battery cell 1100, which reduces the internal resistance and charge/discharge times of Li-ion battery cell 1100 and improves adhesion between adjacent layers of Li-ion battery cell 1100. Electrolyte layer 1102 electrically isolates the anode and cathode of Li-ion battery cell 1100, i.e., anodic structure 1101 and a cathode layer 1103, respectively, while providing ionic conductivity therebetween during charging and discharging of Li-ion battery cell 1100.

In FIG. 11C, cathode layer 1103 has been conformally deposited on electrolyte layer 1102, as shown. Cathode layer 1103 includes an active cathodic material, such as a lithium metal oxide. Examples of active cathodic material suitable for use in cathodic layer 1103 include lithium cobalt oxide (LiCoO₂), Lithium iron phosphate (LiFePO₄), and lithium manganese oxide (LiMn₂O₄). The conformal deposition of cathode layer 1103 ensures that surface 1103A provides a very high surface area interface for subsequently depositing a current collector layer 1104 thereon. Cathode layer 1103 may be formed using PVD, thermal evaporation, or other methods known in the art.

In FIG. 11D, current collector layer 1104 has been conformally deposited on electrolyte layer 1102, as shown. Current collector layer 1104 includes a metal film and acts as the current collector for the cathode of Li-ion battery cell 1100. Examples of metal films suitable for use in current collector layer 1104 include aluminum (Al), copper (Cu), and nickel (Ni), among others. In one embodiment, current collector layer 1104 is deposited so that the surface 1104A is substantially planar, so the thickness may be substantially thicker than other layers making up Li-ion battery cell 1100. Techniques known in the art for providing such a planar surface include electrochemical plating, and, for more temperature-resistant substrate, PVD reflow and thermal evaporation.

Li-ion battery cell 1100 may be packaged to electrically isolate the cathode and anode of the cell from the external environment. In one embodiment, electrical contact foils are attached to current collectors, for example along one or more edges of Li-ion battery cell 1100, and the cell and contact foils are then packaged together using plastic, polymeric, or aluminum oxide (Al₂O₃) laminate films. In another embodiment, Li-ion battery cell 1100 is first packaged in laminate films that include windows exposing contact pads on current collector of 1101 and surface 1104A of current collector layer 1104 for subsequent electrical connection thereto.

In sum, Li-ion battery cell 1100 is a functional Li-ion battery cell that is formed on a substrate by the deposition of sequential thin films. Because the surfaces of each thin film have a very rough, three-dimensional configuration, Li-ion battery cell 1100 may provide energy storage with a high energy density with respect to the weight and/or volume of the cell. In addition, the substantially planar configuration of Li-ion battery cell 1100 allows a large number of such cells to be stacked together to form a complete battery in a small volume. Further, because Li-ion battery cell 1100 may be formed on a flexible substrate, very large surface area substrates may be used, e.g., on the order of 1 m×1 m or larger. Because a flexible substrate may be used to form Li-ion battery cell 1100, roll-to-roll processing techniques may be used, avoiding the more complex handling, lower throughput, and higher costs associated with single-substrate processing.

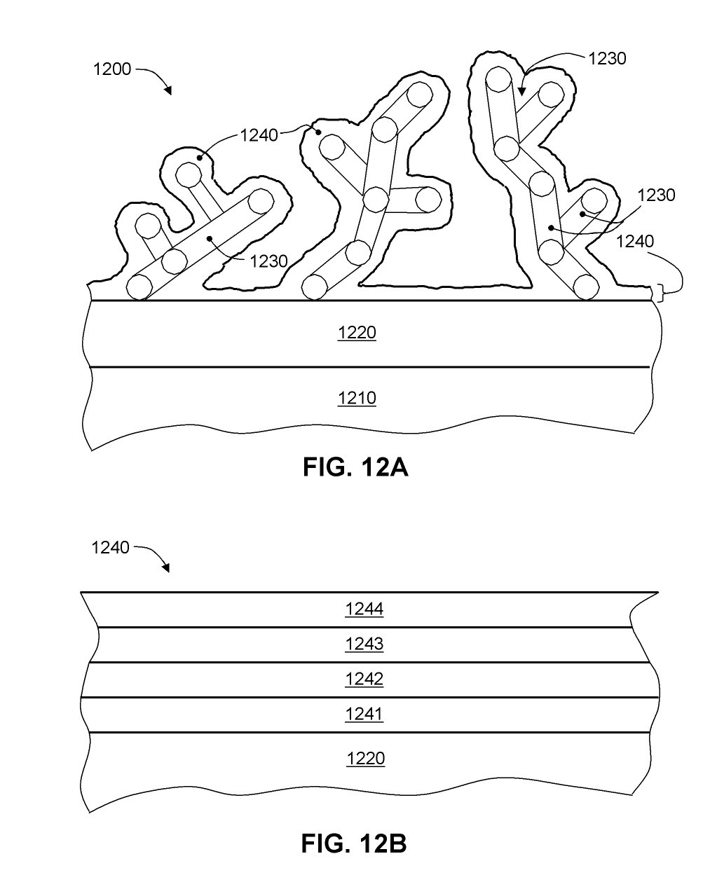

FIG. 12A illustrates a partial schematic cross-sectional view of a Li-ion battery cell 1200 formed from sequentially deposited thin-film layers, according to another embodiment of the invention. Li-ion battery cell 1200 includes a flexible substrate 1210, an anodic current collector 1220, a fullerene hybrid material 1230, and a plurality of sequentially deposited thin-film layers 1240. Flexible substrate 1210 may be substantially similar to non-conductive substrate 120 in FIG. 1. Anodic current collector 1220 is a conductive metal thin film, such as a copper (Cu) film, deposited on flexible substrate 1210. Fullerene hybrid material 1230 is formed on anodic current collector 1220 and may be substantially similar to fullerene-hybrid material 102 in FIG. 1. Fullerene hybrid material 1230 acts as a mechanically stable, electrically conducive, three-dimensional host material for the deposition of sequentially deposited thin-film layers 1240. Sequentially deposited thin-film layers 1240 are deposited on fullerene hybrid material 1230, as shown, to form Li-ion battery cell 1200.

FIG. 12B is a schematic cross-sectional view of a portion of sequentially deposited thin-film layers 1240, according to an embodiment of the invention. Sequentially deposited thin-film layers 1240 include a layer of anodic material 1241, a layer of electrolyte/separator material 1242, a layer of cathodic material 1243, and a layer of cathodic current collector material 1244. Anodic material 1241 may be formed from tin-cobalt-titanium (SnCoTi), tin-copper-titanium (SnCuTi), lithium-titanium-oxygen (LiTiO), their oxides, or their carbonates. Electrolyte/separator material may be UPON or its variations. Cathodic material 1243 may be a lithium metal oxide, such as LiFePO, LiMnO, or LiCoNiO. Cathodic current collector material 1244 may be a conformally deposited and electrically conductive metal film, such as aluminum. In one embodiment, an additional and relatively thick layer of conductive metal may be formed on cathodic material 1243, thereby reducing internal resistance of Li-ion battery cell 1200 and providing a substantially planar top surface to Li-ion battery cell 1200.

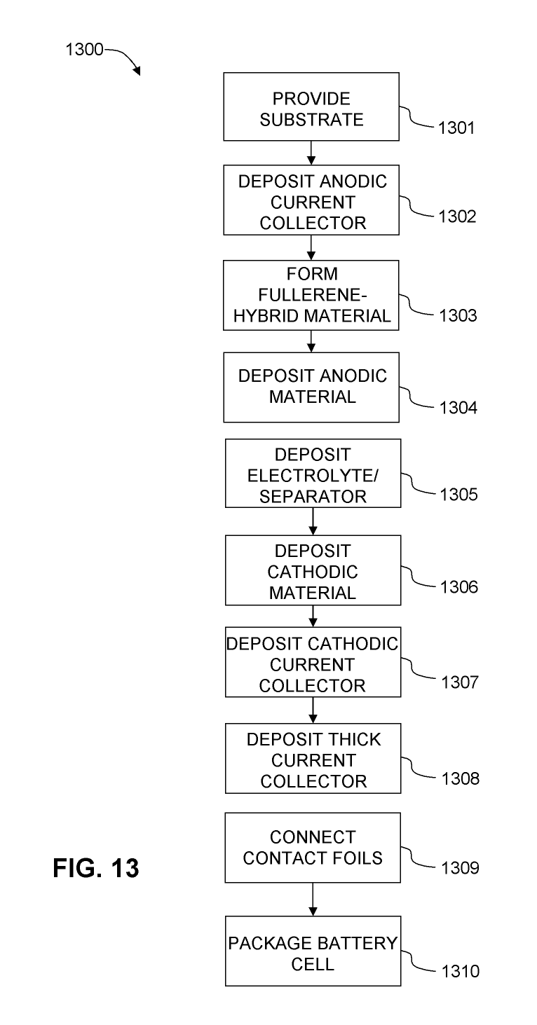

FIG. 13 is a process flow chart summarizing a method 1300 for forming Li-ion battery cell 1200, according to one embodiment of the invention. In step 1301, a flexible substrate 1210 is provided. In step 1302, anodic current collector 1220 is deposited on flexible substrate 1210 using electrochemical plating, CVD or other techniques known in the art. In step 1303, fullerene hybrid material 1230 is formed on anodic current collector 1220 as described above in step 803 of method 800. In step 1304, a layer of anodic material 1241 is conformally deposited on the three-dimensional surface of fullerene hybrid material 1230 using any of the thin-film metal deposition processes described above in step 803 of method 800. In step 1305, a layer of electrolyte/separator material 1242 is conformally deposited on the three-dimensional surface of anodic material 1241 using any of the thin-film deposition processes described above in step 804 of method 800. In step 1306, a layer of cathodic material 1243 is conformally deposited on the three-dimensional surface of electrolyte/separator material 1242 using any of the thin-film metal deposition processes described above in step 803 of method 800. In step 1307, a layer of cathodic current collector material 1244 is conformally deposited on the three-dimensional surface of cathodic material 1243 using any of the thin-film metal deposition processes described above in step 803 of method 800. In an optional step 1308, a relatively thick metallic layer may be deposited on the three-dimensional surface of cathodic collector material 1244 to form a substantially planar top surface of Li-ion battery cell 1200 and to reduce internal resistance of Li-ion battery cell 1200. In step 1309, contact foil tabs may be connected to anodic current collector 1220 and the cathodic collector (either cathodic collector material 1244 or the optional thick metallic layer). In step 1310, Li-ion battery cell 1200 may be packaged using a lamination process with a packaging film-foil, such as an Al/Al₂O₃ foil.

While the foregoing is directed to embodiments of the present invention, other and further embodiments of the invention may be devised without departing from the basic scope thereof, and the scope thereof is determined by the claims that follow.

We claim:

1. An electrode structure, comprising:
a conductive substrate;
a fullerene-hybrid material formed on a surface of the conductive substrate; and
a metallic layer conformally deposited on the fullerene-hybrid material and at least a portion of the surface of the conductive substrate.

2. The electrode structure of claim 1, wherein the fullerene-hybrid material is comprised of carbon fullerene onions linked by carbon nanotubes to form a high-surface-area layer having a three-dimensional surface.

3. The electrode structure of claim 2, wherein the carbon fullerene onions comprises C₆₀, C₇₀, C₇₂, C₈₄, or C₁₁₂ molecules.

4. The electrode structure of claim 2, wherein the fullerene-hybrid material comprises high-aspect-ratio chains of spherical carbon fullerene onions.

5. The electrode structure of claim 2, wherein the fullerene-hybrid material is a high-aspect ratio configuration of spherical carbon fullerene onions connected by single-walled or multi-walled carbon nanotubes.

6. The electrode structure of claim 5, further comprising a single-walled carbon nanotube shell surrounding one or more of spherical carbon fullerene onions.

7. The electrode structure of claim 4, wherein the high-aspect-ratio chains of spherical carbon fullerene onions are at least about 1 micron to about 20 micron in length.

8. The electrode structure of claim 1, wherein the metallic layer comprises a material selected from a group consisting of copper (Cu), cobalt (Co), nickel (Ni), aluminum (Al), zinc (Zn), magnesium (Mg), tungsten (W), their alloys, their oxides, their lithium-containing compounds, and tin (Sn), tin-cobalt (SnCo), tin-copper (Sn—Cu), tin-cobalt-titanium (Sn—Co—Ti), tin-copper-titanium (Sn—Cu—Ti), and their oxides.

9. The electrode structure of claim 1, wherein the metallic layer has a thickness less than about 0.1 μm to 1 μm.

10. The electrode structure of claim 1, wherein the fullerene-hybrid material comprises a first carbon fullerene onion, a second carbon fullerene onion connected to the first carbon fullerene onion by a first carbon nanotube having a first diameter, and a third carbon fullerene onion connected to the first carbon fullerene onion by a second carbon nanotube having a second diameter, and wherein the first and second diameters are less than about half of a diameter of the first carbon fullerene onion.

11. A lithium-ion battery having an electrode structure, comprising:
an anodic structure, comprising:
a conductive substrate;
a fullerene-hybrid material formed on a surface of the conductive substrate; and
an active anodic material layer conformally deposited on the fullerene-hybrid material and at least a portion of the conductive substrate;
an electrolyte-separator layer conformally deposited on the active anodic material layer;
an active cathodic material layer conformally deposited on the electrolyte-separator layer; and
a metallic layer conformally deposited on the cathodic material layer.

12. The lithium-ion battery of claim 11, wherein the fullerene-hybrid material is comprised of carbon fullerene onions linked by carbon nanotubes to form a high-surface-area layer having a three-dimensional surface.

13. The lithium-ion battery of claim 11, wherein the electrolyte-separator layer comprises a lithium-containing inorganic material.

14. The lithium-ion battery of claim 11, wherein the active anodic material layer comprises tin-cobalt-titanium (SnCoTi), tin-copper-titanium (SnCuTi), lithium-titanium-oxygen (LiTiO), oxides thereof, or carbonates thereof.

15. The lithium-ion battery of claim 11, wherein the active cathodic material layer comprises lithium metal oxides such as LiFePO, LiMnO, LiCoNiO, lithium cobalt oxide (LiCoO₂), Lithium iron phosphate (LiFePO₄), or lithium manganese oxide (LiMn₂O₄).

16. The lithium-ion battery of claim 11, wherein the metallic layer has a substantially planar surface.

17. The lithium-ion battery of claim 11, wherein the conductive substrate is a flexible substrate.

18. A lithium-ion battery, comprising:
a conductive substrate;
a fullerene-hybrid material formed on a surface of the conductive substrate;
a first metallic layer conformally deposited on the fullerene-hybrid material;
an anodic material layer conformally deposited on the metallic layer;
an electrolyte-separator layer conformally deposited on the anodic material layer;
an active cathodic material layer conformally deposited on the electrolyte-separator layer;
a second metallic layer conformally deposited on the active cathodic material layer;
a thick metallic layer deposited on the conformal metallic layer to form a substantially planar surface;
a first contact foil tab connected to the thick metallic layer;
a second contact foil tab connected to the conductive substrate; and
a packaging encapsulation film-foil applied by lamination.

19. A method of forming an electrode structure, comprising:
vaporizing a high molecular weight hydrocarbon precursor;
directing the vaporized high molecular weight hydrocarbon precursor onto a conductive substrate to deposit a fullerene-hybrid material thereon; and
depositing a thin metallic layer onto the fullerene-hybrid material using a thin-film metal deposition process, wherein the thin metallic layer is in good electrical contact with a surface of the conductive substrate, and the high molecular weight hydrocarbon precursor comprises molecules having at least 18 carbon (C) atoms.

20. The method of claim 19, further comprising:
depositing an electrolyte onto the thin metallic layer, wherein the electrolyte is formed from lithium phosphorous oxyNitride (LiPON), lithium-oxygen-phosphorus (LiOP), lithium-phosphorus (LiP), lithium polymer electrolyte, lithium bisoxalatoborate (LiBOB), lithium hexafluorophosphate (LiPF₆) in combination with ethylene carbonate (C₃H₄O₃), dimethylene carbonate (C₃H₆O₃), or ionic liquids.
